(19) United States
(12) Patent Application Publication
(10) Pub. No.: US 2002/0040662 A1
(43) Pub. Date: Apr. 11, 2002

(54) Process for preparing liquid pigment preparations

(75) Inventors: Erwin Dietz, Konigstein (DE); Joachim Weber, Frankfurt am Main (DE); Dieter Schnaitmann, Eppstein (DE); Christian Wille, Weinheim (DE); Leonhard Unverdorben, Nidderau (DE)

Correspondence Address: CLARIANT CORPORATION, 4331 CHESAPEAKE DR, ATTN: INDUSTRIAL PROPERTY DEPT, CHARLOTTE, NC, 28216, US

(73) Assignee: Clariant GmbH

(21) Appl. No.: 09/971,495

(22) Filed: Oct. 5, 2001

(30) Foreign Application Priority Data
Oct. 5, 2000 (DE) 10049202.9

(51) Int. Cl. C04B 14/00

(52) U.S. Cl. 106/400

(57) ABSTRACT

The invention provides a process for preparing liquid pigment preparations which comprises spraying a from 10 to 80% by weight suspension of a crude pigment, prepigment and/or pigment, based on the overall weight of the suspension, in a flocculation-stabilizing, liquid medium through nozzles to a point of conjoint collision in a reactor chamber enclosed by a housing in a microjet reactor, a gas or an evaporating liquid being passed into the reactor chamber through an opening in the housing for the purpose of maintaining a gas atmosphere in the reactor chamber, and the resulting liquid pigment preparation and the gas or the evaporated liquid being removed from the reactor through a further opening in the housing by means of overpressure on the gas entry side or underpressure on the product and gas exit side.

### BACKGROUND OF THE INVENTION

The present invention describes an environment-friendly and economic process for preparing liquid pigment preparations.

Pigment preparations are dispersions of pigments in flocculation-stabilizing, liquid media. In addition to the pigment and the flocculation-stabilizing, liquid medium it is also possible for auxiliaries to be present. The pigments are dispersed in, and completely enveloped by, the flocculation-stabilizing, liquid medium. The flocculation-stabilizing, liquid media are similar to or highly compatible with the intended application medium. The pigments are present in the pigment preparations in higher concentrations than in the subsequent application medium.

Pigment preparations are used as colorants for pigmenting high molecular mass materials, such as varnishes, emulsion paints, inks such as inkjet inks, for example, printing inks, plastics, and textile printing inks. The incorporation of pigments into these media is frequently accompanied by difficulties, since numerous pigments can be brought into a dispersed state in the application medium, with satisfactory performance properties, only with great effort. If the pigment particles are too coarse, useful results cannot be achieved: for example, the optimum color strength is not attained. During and after a dispersing operation, flocculation phenomena may occur which lead to viscosity changes in the application medium, changes in shade and losses of color strength, hiding power, gloss, homogeneity, and brilliance in the colored materials. These difficulties may be avoided through the use of appropriate pigment preparations. Pigment preparations can normally be incorporated into the flocculation-stabilizing liquid media with minimal dispersion and mixing effort, and without environmental problems, and are notable in many application media for their outstanding coloristic and rheological properties and also for favorable flocculation behavior and settling behavior.

Normally, finely divided pigments are used to prepare pigment preparations. In this case, incorporation into the flocculation-stabilizing, liquid media takes place by dispersion in roll mills, vibration mills, stirred ball mills with low and high energy density, mixers, roller beds or extruders. The dispersion apparatus used is dependent on the dispersibility of the pigment used, on the flocculation-stabilizing, liquid medium, and on the auxiliaries. In certain cases, the crude, coarsely crystalline pigments are used as well. In this case, fine division and dispersion are combined with one another in a simple way and there is no need for the laborious fine division of the crude, coarsely crystalline pigments in flocculation-unstable media, or for the finishing operation.

With the processes known to date, the energy is introduced mechanically; the greatest part of the energy is converted into heat, with only a fraction of the energy introduced being used effectively for grinding and fine division. When grinding media such as beads are used, there is abrasion and hence product contamination by extraneous substances. The scaleup of new products from the laboratory to the industrial scale is often complex and may cause difficulties, since the introduction of the mechanical energy, the transmission of the energy for effective grinding, the loss of energy through heat production, and the necessary dissipation of the heat, for example, depend greatly on the geometries and sizes of the apparatus and hence also co-determine the economics of the process on the industrial scale.

EP-A-0 753 544 describes a process for preparing pigment preparations by wet grinding using stirred ball mills with high energy density. As a result of the use of grinding media, abrasion occurs and hence the product is contaminated by extraneous substances.

### SUMMARY OF THE INVENTION

It is an object of the present invention to develop a universally applicable, cost-effective, technically reliable and economic process for preparing pigment preparations on the basis of pigments of different classes and different flocculation-stabilizing, liquid media for various fields of use, which allows unproblematic scaleup while preventing any possibility of contamination by extraneous substances.

It has been found that the object of the invention may be achieved, surprisingly, through the use of a microjet reactor.

The present invention provides a process for preparing liquid pigment preparations which comprises spraying a from 10 to 80% by weight, preferably from 20 to 60% by weight, in particular from 30 to 50% by weight, suspension of a crude pigment, prepigment and/or pigment, based on the overall weight of the suspension, in a flocculation-stabilizing, liquid medium through nozzles to a point of conjoint collision in a reactor chamber enclosed by a housing in a microjet reactor, appropriately via one or more pumps, preferably high-pressure pumps, a gas or an evaporating liquid being passed into the reactor chamber through an opening in the housing for the purpose of maintaining a gas atmosphere in the reactor chamber, especially at the point of collision of the suspension jets, and where appropriate of effecting cooling as well, and the resulting liquid pigment preparation and the gas or the evaporated liquid being removed from the reactor through a further opening in the housing by means of overpressure on the gas entry side or underpressure on the product and gas exit side.

### DESCRIPTION OF THE PREFERRED EMBODIMENTS

Preparing the liquid pigment preparations in accordance with the invention requires a high grinding and dispersing action. This is brought about by spraying the suspensions used into the reactor chamber under a pressure of at least 50 bar, preferably at least 500 bar, in particular from 500 to 5000 bar.

In order to prevent material wear on the inner surfaces of the housing, the collision point is shifted into the material-remote gas space. By “material-remote” here is meant that, in the vicinity of the collision point of the jets, a gas atmosphere is maintained by means of the introduced gas or evaporating liquid. This means that the collision point at which the jets impinge on one another is not sited on a vessel wall or on a pipe wall. This prevents the material wear that would occur at the point where cavitation takes place on material walls. Cavitation occurs particularly when using high pressures, especially at pressures above 3000 bar. Moreover, the colliding jets are not braked by the gas atmosphere prior to their collision, as would be the case, for example, if they had to pass through a liquid.

The material of the nozzles should be as hard and thus low-wearing as possible; examples of suitable materials include ceramics, such as oxides, carbides, nitrides or mixed compounds thereof, with preference being given to the use of aluminum oxide, particularly in the form of sapphire or ruby, although diamond is also particularly suitable. Suitable hard substances also include metals, especially hardened metals. The bores of the nozzles have diameters of less than 2 mm, preferably less than 0.5 mm and in particular less than 0.4 mm.

The microjet reactor may be configured in principle as a two-jet, three-jet or multijet reactor, preference being given to a two-jet configuration. In a case of an arrangement with two jets, the jets preferably strike one another frontally (180° angle between the jets); in the case of a three-jet arrangement, an angle of 120° between the jets is appropriate. The jets advantageously may be mounted in a device which can be adjusted to the point of conjoint collision.

In one particularly preferred embodiment of the process of the invention, the suspension jets are sprayed against one another frontally through two opposed nozzles by means of a high-pressure pump.

The temperatures of the supplied suspensions are situated appropriately in the range from −50 to 250° C., preferably from 0 to 180° C., particularly between 0 and 100° C., especially between 10 to 80° C. It is also possible to operate under pressure at above the boiling point of the flocculation-stabilizing, liquid medium.

Where necessary, the introduced gas or the evaporating liquid that is used to maintain the gas atmosphere in the inside of the housing may be used for cooling. Additionally, an evaporating cooling liquid or a cooling gas may be introduced into the reactor chamber by way of an additional bore in the housing. The aggregate state of the cooling medium may be conditioned by temperature and/or pressure. The medium in question may comprise, for example, air, nitrogen, carbon dioxide or other, inert gases or liquids having an appropriate boiling point under increased pressure. It is possible here for the transition of the cooling medium from the liquid to the gaseous state to take place in the reactor itself by virtue of the fact that heat released in the course of grinding brings about the change in aggregate state. It is also possible for the evaporative cooling of an expanding gas to be utilized for cooling. The housing enclosing the reactor chamber may also be constructed in such a way that it is thermostatable and may be used for cooling; or else the product may be cooled after it has exited the housing. The pressure in the reactor chamber may, for example, be set and maintained by means of a pressure maintenance valve, so that the gas used is present in the liquid or supercritical or subcritical state. Thus it is possible, for example, to utilize the evaporative cooling of a gas.

If operation is to take place at elevated temperature, the energy required for heating may be supplied prior to the emergence from the nozzles of the suspension—for example, in the supply lines—or by way of the thermostatable housing or the introduced gas. In principle, owing to the high pressures in the high-pressure lances, the chosen temperature may also be situated a considerable way above the boiling point of the liquid medium. Suitable liquid media therefore include those which, at the temperature of grinding in the interior of the housing under atmospheric pressure, are present as gases.

Where the intensity of grinding is too low, the desired fine division is not achieved. If desired, therefore, the suspension may also be pumped through the microjet reactor in more than one pass. It is also possible to carry out grinding in circulation. The number of passes, or the duration of grinding in the case of circulation grinding, is dependent on the fineness requirements for the respective field of use. Normally from 1 to 15 passes, preferably from 1 to 10 passes, in particular from 1 to 7 passes, are sufficient.

For the process of the invention it is possible in principle to use any organic or inorganic pigments, examples being organic pigments such as perylene, perinone, quinacridone, quinacridonequinone, anthraquinone, anthanthrone, benzimidazolone, disazo condensation, azo, indanthrone, phthalocyanine, triarylcarbonium, dioxazine, such as triphendioxazine, aminoanthraquinone, diketopyrrolopyrrole, indigo, thioindigo, thiazineindigo, isoindoline, isoindolinone, pyranthrone, isoviolanthrone, flavanthrone, anthrapyrimidine or carbon black pigments, mixed crystals or mixtures thereof; or inorganic pigments such as titanium dioxide, zinc sulfide, zinc oxide, iron oxide, chromium oxide, mixed metal oxide (such as nickel rutile yellow, chromium rutile yellow, cobalt blue, cobalt green, zinc iron brown, spinel black), cadmium, bismuth, chromate, ultramarine, and iron blue pigments and mixtures thereof (see Buxbaum, Industrial Inorganic Pigments, Wiley-VCH, 1998), and mixtures of organic and inorganic pigments. It is appropriate to use the crude pigments obtained in coarsely crystalline form in the course of their synthesis or purification, or mixtures of these crude pigments, pigment formulations of these crude pigments, surface-treated crude pigments or coarsely crystalline crude mixed-crystal pigments, especially coarsely crystalline crude quinacridone pigments of the beta or gamma phase, coarsely crystalline crude quinacridone mixed-crystal pigments, crude, coarsely crystalline copper phthalocyanine pigments of the alpha or beta phase, coarsely crystalline chlorinated copper phthalocyanines, and crude, coarsely crystalline dioxazine, perylene, indanthrone, perinone, quinacridonequinone, anthraquinone, aminoanthraquinone and anthanthrone pigments.

Coarsely crystalline crude pigments are crude pigments which are only suitable for pigmenting organic materials after their particles have been reduced in size. In the majority of cases, these crude pigments have an average particle size D₅₀ of more than 1 μm.

It is also possible to use prepigments which have already been finely divided but which are highly agglomerated and therefore difficult to disperse, or pigments which are difficult to disperse, or else mixtures of coarsely crystalline crude pigments, prepigments, and pigments. It is of course also possible to convert readily dispersible pigments, prepigments or crude pigments into pigment preparations by the process of the invention.

The dispersion properties of a pigment are its properties in the course of dispersion in respect of changes in various criteria of the dispersion state (for example, particle size, color strength, gloss) as a function of various parameters (dispersing apparatus, dispersing process, dispersing time, millbase composition).

In order to assess the dispersion characteristics of difficult-to-disperse pigments, it is principally the color strength that is employed. It increases with increasing quality of the dispersion state and with increasing particle fineness. Consequently, it is also possible to use the average particle diameter (D₅₀) for assessing the dispersibility. The test medium and the dispersing conditions are laid down beforehand in accordance with the field of use of the pigment. A yardstick used is the dispersion effort (dispersing time) required to achieve a certain average particle size. The average particle size is dependent on the pigment that is used in each case. The data obtained are comparable only if dispersing conditions are identical. If the maximum permissible value under standard dispersing conditions (tmax=240 min.) is exceeded, this pigment is difficult to disperse and is unsuitable for use in preparing pigment preparations in a conventional stirred ball mill.

Examples of prepigments which are considered difficult to disperse are dioxazine, phthalocyanine, anthanthrone, perylene, and quinacridone prepigments. Pigments regarded as difficult to disperse include azo, dioxazine, phthalocyanine, anthanthrone, perylene, quinacridone, diketopyrrolopyrrole, isoindolinone and isoindoline pigments.

The term flocculation-stabilizing, liquid medium refers to a medium that prevents the reagglomeration of the dispersed pigment particles in the dispersion. The flocculation resistance is determined by means of the rubout test, in which the difference in color strength or difference in shade between the flocculated and the deflocculated sample is measured. A flocculation-stabilizing, liquid medium in the sense of the present invention produces a difference in color strength of less than 10%. The color strength is determined here in accordance with DIN 55986.

The flocculation-stabilizing, liquid medium comprises one or more carrier materials and, where appropriate, water, and/or one or more of the organic solvents mentioned below.

Examples of suitable carrier materials include the following: pigmentary and nonpigmentary dispersants; resins, such as novolaks, alkyd melamine resins, acrylic melamine resins or polyurethane resins; plasticizers, such as diisodecyl phthalate or dioctyl phthalate.

Surfactants, for example, are of interest as nonpigmentary dispersants.

Suitable surfactants include anionic or anion-active, cationic or cation-active, and nonionic substances or mixtures of these agents. Preference is given to those surfactants or surfactant mixtures which do not foam in the course of the grinding. Examples of suitable anion-active substances include fatty acid taurides, fatty acid N-methyltaurides, fatty acid isethionates, alkylphenylsulfonates, alkylnaphthalinesulfonates, alkylphenol polyglycol ether sulfates, fatty alcohol polyglycol ether sulfates, fatty acid amide polyglycol ether sulfates, alkyl sulfosuccinamates, alkenylsuccinic monoesters, fatty alcohol polyglycol ether sulfosuccinates, alkanesulfonates, fatty acid glutamates, alkyl sulfosuccinates, fatty acid sarcosides; fatty acids, such as palmitic, stearic, and oleic acid; soaps, such as alkali metal salts of fatty acids, naphthenic acids and resin acids, such as abietic acid; alkali-soluble resins, examples being rosin-modified maleate resins, and condensation products based on cyanuric chloride, taurine, N,N′-diethylaminopropylamine, and p-phenylenediamine. Particular preference is given to resin soaps, i.e., alkali metal salts of resin acids.

Examples of suitable cation-active substances include quaternary ammonium salts, fatty amine alkoxylates, alkoxylated polyamines, fatty amine polyglycol ethers, fatty amines, diamines and polyamines derived from fatty amines or fatty alcohols, and their alkoxylates, imidazolines derived from fatty acids, and salts of these cation-active substances, such as acetate, for example.

Examples of suitable nonionic substances include amine oxides, fatty alcohol polyglycol ethers, fatty acid polyglycol esters, betaines, such as fatty acid amide N-propyl betaines, phosphoric esters of aliphatic and aromatic alcohols, fatty alcohols or fatty alcohol polyglycol ethers; fatty acid amide ethoxylates, fatty alcohol-alkylene oxide adducts, and alkylphenol polyglycol ethers.

Particularly of interest are fatty amine polyglycol ethers, fatty acid taurides, fatty alcohol polyglycol ethers, fatty acid polyglycol esters, fatty acid N-methyltaurides, fatty acid sarcosides, fatty acid isethionates, alkylphenol polyglycol ethers, alkylnaphthalenesulfonates, alkylphenylsulfonates, alkylphenol polyglycol ether sulfates, fatty alcohol polyglycol ether sulfates and fatty amine acetates.

By nonpigmentary dispersants are also meant substances which structurally are not derived by chemical modification from organic pigments. They are added as dispersants either during the actual preparation of pigments, or else often during the incorporation of the pigments into the application media to be colored; for example in the preparation of paints or printing inks, by dispersion of the pigments into the corresponding binders. They may be polymeric substances, examples being polyolefins, polyesters, polyethers, polyamides, polyimines, polyacrylates, polyisocyanates, block copolymers thereof, copolymers of the corresponding monomers, or polymers of one class modified with a few monomers from another class. These polymeric substances carry polar anchor groups such as hydroxyl, amino, imino, and ammonium groups, for example, carboxylic acid groups and carboxylate groups, sulfonic acid groups and sulfonate groups, or phosphonic acid groups and phosphonate groups, and may also be modified with aromatic, nonpigmentary substances. Nonpigmentary dispersants may also, furthermore, be aromatic substances chemically modified with functional groups and not derived from organic pigments. Nonpigmentary dispersants of this kind are known to the skilled worker, and some are available commercially (e.g., Solsperse®, Avecia; Disperbyk®, Byk, Efka®, Efka). Although several types will be mentioned below to give a representation, it is possible in principle to employ any other substances described, examples being condensation products of isocyanates and alcohols, diols or polyols, amino alcohols or diamines or polyamines, polymers of hydroxycarboxylic acids, copolymers of olefin monomers or vinyl monomers and ethylenically unsaturated carboxylic acids/esters, urethane-containing polymers of ethylenically unsaturated monomers, urethane-modified polyesters, condensation products based on cyanuric halides, polymers containing nitroxyl compounds, polyester amides, modified polyamides, modified acrylic polymers, comb dispersants comprising polyesters and acrylic polymers, phosphoric esters, triazine-derived polymers, modified polyethers, or dispersants derived from aromatic nonpigmentary substances. These parent structures are in many cases modified further, by means for example of chemical reaction with further substances carrying functional groups or by salt formation.

By pigmentary dispersants are meant pigment dispersants which are derived from an organic pigment as the parent structure and are prepared by chemically modifying this parent structure; examples include saccharin-containing pigment dispersants, piperidyl-containing pigment dispersants, naphthalene- or perylene-derived pigment dispersants, pigment dispersants containing functional groups linked to the pigment parent structure via a methylene group, pigment parent structures chemically modified with polymers, pigment dispersants containing sulfo acid groups, pigment dispersants containing sulfonamide groups, pigment dispersants containing ether groups, or pigment dispersants containing carboxylic acid, carboxylic ester or carboxamide groups.

Suitable organic solvents of the flocculation-stabilizing, liquid medium in the sense of the present invention include—where appropriate, water-miscible—alcohols, glycols and glycol ethers, such as ethanol, ethylene glycol, propylene glycol, butylene glycol, diethylene glycol, triethylene glycol, ethylene glycol dimethyl ether or glycerol; polyglycols, such as polyethylene glycols or polypropylene glycols; polyols; polyetherpolyols; aromatic solvents, such as white spirit, for example; ketones, such as methyl ethyl ketone, for example; or esters, such as butyl esters, for example.

The flocculation-stabilizing, liquid medium may further comprise, where appropriate, one or more auxiliaries, such as fillers, standardizers, waxes, defoamers, extenders, preservatives, drying retardants, such as sugars, e.g., cane sugar, or ureas, rheology control additives, wetting agents, antioxidants, UV absorbers, light stabilizers, or a combination thereof, in an amount of from 0 to 30% by weight, based on the overall weight of the liquid pigment preparation.

By way of example, water on its own, monohydric alcohols, ketones or mixtures thereof with water, without a carrier material, are not flocculation-stabilizing, liquid media in the sense of the present invention.

The process of the invention may be conducted at any desired pH; by way of example, preference is given to neutral to alkaline pH values in the case of aqueous preparations which are used for emulsion paints.

The pigment preparations are obtained in the form of liquid dispersions, doughs or pastes. The viscosity may vary within wide ranges, being preferably from 0.01 to 35 Pas, with particular preference from 0.05 to 25 Pas, in particular from 0.05 to 10 Pas. The only critical factor is that the pigment preparation can still be conveyed.

The number of passes depends on the fineness requirement for the particular field of use, such as the coatings, printing or plastics field, for example.

Utilizing the available possibilities for variation, pigment preparations may be produced for different end uses. This may be directed by way of the nature of the crude pigment, prepigment or pigment, the nature of the carrier material, of the solvent, and of the auxiliaries, and also by their concentration, the number of passes, and the temperature.

The production of pigment preparations by the process of the invention has proven particularly economic and environment-friendly since it does not entail any air contamination as a result of dusting. Moreover, only small amounts of chemicals and solvents are used, which can be processed further subsequently. Accordingly, there are no disposal problems arising.

When coarsely crystalline crude pigments are employed, the conventional laborious fine dispersion and the solvent finish for conversion into the pigmentary form are unnecessary. The solvent losses resulting from the hitherto necessary solvent finish are avoided, and there is no need for complex apparatus for the solvent finish and for solvent regeneration.

Where grinding is carried out in an aqueous or aqueous-organic medium, it is possible to use the moist crude pigments or prepigments. As a result, there is no need for expensive drying. Because the same fine division apparatus is used for all fields of use, the uneconomic maintaining of different kinds of fine division apparatus is unnecessary.

It was surprising and not foreseeable that the production of liquid pigment preparations would be possible in this simple and technically uncomplicated way through the collision of jets in a microjet reactor, and that the fine division and dispersion of coarsely crystalline crude pigments would be achievable in a single stage.

The pigments obtainable in accordance with the present invention are notable for their outstanding coloristic and rheological properties; in particular, high flocculation stability, ease of dispersion, good sedimentation behavior and advantageous gloss characteristics, and high color strength and storage stability.

The pigment preparations prepared in accordance with the invention may be used for pigmenting natural or synthetic organic materials of high molecular mass, such as cellulose ethers and cellulose esters, such as ethylcellulose, nitrocellulose, cellulose acetate or cellulose butyrate, for example, natural resins or synthetic resins, such as addition-polymerization resins or condensation resins, examples being amino resins, especially urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, and polyacrylates, polyamides, polyurethanes or polyesters, rubber, latices, casein, silicones, and silicone resins, individually or in mixtures.

In this context it is unimportant whether the high molecular mass organic compounds mentioned are in the form of plastically deformable masses, casting resins, pastes, melts or spinning solutions, paints, stains, foams, drawing inks, writing inks, mordants, coating materials, emulsion paints or printing inks.

The pigment preparations prepared in accordance with the invention are also suitable for use as colorants in electrophotographic toners and developers, such as one- or two-component powder toners (also called one- or two-component developers), magnetic toners, liquid toners, addition-polymerization toners, and also specialty toners. Typical toner binders are addition-polymerization, polyaddition, and polycondensation resins, such as styrene, styrene-acrylate, styrene-butadiene, acrylate, polyester, and phenol-epoxy resins, polysulfones, polyurethanes, individually or in combination, and also polyethylene and polypropylene, which may contain further ingredients, such as charge control agents, waxes or flow aids, or may be subsequently modified with these additives.

Additionally, the pigment preparations prepared in accordance with the invention are suitable for use as colorants in powders and powder coating materials, especially in triboelectrically or electrokinetically sprayable powder coating materials that are used to coat the surfaces of articles made, for example, of metal, wood, plastic, glass, ceramic, concrete, textile material, paper or rubber.

Typical powder coating resins employed are epoxy resins, carboxyl- and hydroxyl-containing polyester resins, polyurethane resins and acrylic resins, together with customary curing agents. Combinations of resins are also used. For example, epoxy resins are frequently used in combination with carboxyl- and hydroxyl-containing polyester resins. Typical curing components (depending on the resin system) are, for example, acid anhydrides, imidazoles, and also dicyandiamide and its derivatives, blocked isocyanates, bisacylurethanes, phenolic and melamine resins, triglycidyl isocyanurates, oxazolines, and dicarboxylic acids.

Moreover, the pigment preparations prepared in accordance with the invention are suitable for use as colorants in inkjet inks on an aqueous and nonaqueous basis, and also in those inks which operate in accordance with the hotmelt process.

Furthermore, the pigment preparations prepared in accordance with the invention are also suitable as colorants for color filters, both for subtractive and for additive color generation.

### EXAMPLES

In order to assess the properties in the field of aqueous emulsion paints of the pigment preparations produced in accordance with the present invention, an emulsion paint based on polyvinyl acetate (PVA emulsion paint) was selected.

The color strength and hue were determined in accordance with DIN 55986.

The crystal phase was determined by means of X-ray spectroscopy. The X-ray spectra were recorded using CuKα radiation.

The average particle diameter D₅₀ of the coarsely crystalline crude pigments was determined by means of laser light scattering.

The average particle diameter D₅₀ of the pigments in the pigment preparations was determined by graphical evaluation of electron micrographs.

In the preceding text and in the following examples, parts and percentages are each by weight of the substances so described.

### Example 1

3800 parts of a customary commercial P.R. 168 pigment, 400 parts of a pentanuclear nonylphenol condensate of formaldehyde and nonylphenol and 600 parts of an ethoxylated oleyl alcohol are stirred in 2500 parts of ethylene glycol and 2700 parts of water. This suspension is sprayed onto itself through the frontally opposed nozzles in a two-jet microjet reactor at a pressure of 3800 bar. The nozzles each have a diameter of 100 μm and the jets meet in the gas space. The suspension is conveyed out of the microjet reactor by means of compressed air. A total of 5 passes are carried out. A pigment preparation of high color strength is produced.

1. A process for preparing liquid pigment preparations which comprises spraying a from 10 to 80% by weight suspension of a crude pigment, prepigment and/or pigment, based on the overall weight of the suspension, in a flocculation-stabilizing, liquid medium through nozzles to a point of conjoint collision in a reactor chamber enclosed by a housing in a microjet reactor, a gas or an evaporating liquid being passed into the reactor chamber through an opening in the housing for the purpose of maintaining a gas atmosphere in the reactor chamber, and the resulting liquid pigment preparation and the gas or the evaporated liquid being removed from the reactor through a further opening in the housing by means of overpressure on the gas entry side or underpressure on the product and gas exit side.

2. The process as claimed in claim 1, wherein the concentration of crude pigment, prepigment and/or pigment in the suspension is from 20 to 60% by weight, preferably from 30 to 50% by weight.

3. The process as claimed in claim 1, wherein the suspension is sprayed into the reactor chamber with a pressure of at least 50 bar, preferably from 500 to 5000 bar.

4. The process as claimed in claim 1, wherein the temperature of the suspension is from −50 to 250° C., preferably from 0 to 180° C.

5. The process as claimed in claim 1, wherein the flocculation-stabilizing liquid medium comprises one or more carrier materials selected from the group of pigmentary or nonpigmentary dispersants, resins, plasticizers, and mixtures thereof; and where appropriate comprises water and/or one or more organic solvents, and where appropriate comprises one or more auxiliaries.

6. The process as claimed in claim 5, wherein the auxiliary is a filler, standardizer, wax, defoamer, extender, preservative, drying retardant, rheology control additive, wetting agent, antioxidant, UV absorber, light stabilizer or a combination thereof.

7. The process as claimed in claim 1, wherein the flocculation-stabilising liquid medium is a novolak, alkyd melamine resin, acrylic melamine resin, polyurethane resin, diisodecyl phthalate, dioctyl phthalate, fatty amine polyglycol ether, fatty acid tauride, fatty alcohol polyglycol ether, fatty acid polyglycol ester, fatty acid N-methyltauride, fatty acid sarcoside, fatty acid isethionate, alkylphenol polyglycol ether, alkylnaphthalene sulfonate, alkylphenyl sulfonate, alkylphenol polyglycol ether sulfate, fatty alcohol polyglycol ether sulfate, fatty amine acetate; or a mixture of these compounds with water and/or a solvent selected from the group consisting of alcohols, glycols, glycol ethers, polyglycols, polyols, polyetherpolyols, aromatic solvents, ketones, and esters.

8. The process as claimed in claim 1, wherein crude pigments, prepigments and/or pigments are used selected from the group consisting of perylene, perinone, quinacridone, quinacridonequinone, anthraquinone, anthanthrone, benzimidazolone, disazocondensation, azo, indanthrone, phthalocyanine, triarylcarbonium, dioxazine, aminoanthraquinone, diketopyrrolopyrrole, indigo, thioindigo, thiazineindigo, isoindoline, isoindolinone, pyranthrone, isoviolanthrone, flavanthrone, anthrapyrimidine pigments or mixed crystals thereof; or carbon black, titanium dioxide, zinc sulfide, zinc oxide, iron oxide, chromium oxide, mixed metal oxide, cadmium, bismuth, chromate, ultramarine, and iron blue pigments; or mixtures thereof.

9. The process as claimed in claim 1, wherein the suspension used is pumped through the microjet reactor in from 1 to 15, preferably from 1 to 10, passes or wherein the suspension is pumped in circulation through the microjet reactor.

10. The process as claimed in claim 1, wherein the gas is air, nitrogen or carbon dioxide.

11. The process as claimed in claim 1, wherein the conjoint collision point is located in a material-remote region of the reactor chamber.

12. The process as claimed in claim 1, wherein the crude pigment, prepigment and/or pigment suspension is sprayed to a point of conjoint collision through two, three or more nozzles.
